(19) United States
(12) Patent Application Publication
(10) Pub. No.: US 2005/0229186 A1
(43) Pub. Date: Oct. 13, 2005

(54) Method and apparatus for dynamic runtime object aggregation

(75) Inventors: David C. Mitchell, Orem, UT (US); Dale K. Mitchell, Orem, UT (US); Bruce P. Mitchell, Orem, UT (US); Scott E. Hamilton, Orem, UT (US); Blaine W. Elliott, Orem, UT (US)

Correspondence Address: THE HECKER LAW GROUP, 1925 CENTURY PARK EAST, SUITE 2300, LOS ANGELES, CA, 90067, US

(73) Assignee: CANYONBRIDGE, INC., Orem, UT (US)

(21) Appl. No.: 11/077,985

(22) Filed: Mar. 10, 2005

Related U.S. Application Data
(60) Provisional application No. 60/553,613, filed on Mar. 15, 2004.

(51) Int. Cl. G06F 9/44

(52) U.S. Cl. 719/315

(57) ABSTRACT

A method and framework for dynamically aggregating data and functionality to runtime objects in order to increase component reuse and ease integration of disparate objects are presented. The present invention makes possible the reuse and integration of virtually any runtime object without consideration of the platform for which the component was originally created. Runtime aggregation of inheritance, fields, functions, and types is presented. Also, methods presented include: Inheritance, data, and method “eclipsing”; Runtime instantiation on an “as needed” basis; Dynamic runtime transformation of objects; and Aggregation design time cuing.

### CROSS-REFERENCE TO RELATED APPLICATIONS

This application claims the benefit of priority from U.S. Provisional Patent Application Ser. No. 60/553,613, filed on Mar. 15, 2004, the specification and figures of which are hereby incorporated by reference.

### FIELD OF THE INVENTION

This invention relates to the field of application development. More specifically the invention relates to development of applications through aggregation of data and functionality to existing objects as a means to component reuse and integration.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights.

### BACKGROUND

With the advent of the Internet, traditional application development paradigms proved insufficient to meet the need for applications that may run on any platform. In addition, the need for highly re-usable application components became apparent as the concept of component integration gained increasing importance to the Web development community.

The need for applications with global reach and potentially global integration has meant that developers look to widely available general purpose components as application building blocks with which to quickly assemble functionality. The adoption of Web services as the Internet application development standard goes a long way to make such components available to any platform, anywhere in the world.

Looking forward, it seems clear that more and more Internet applications will consist of assemblies of objects created in a development environment foreign to the one a given programmer uses to create a particular application. Such foreign components will need to be seamlessly integrated into the application. Web services meet the need for seamless integration, however the ease of integration provided by Web services is only a partial solution to the problems developers currently face.

Challenges of Component Integration

Developers seeking to create integrated applications face two fundamental challenges: First, in order to be easily integrated, a component must be generic and therefore, less useful. The more general purpose a component, the greater the chance the component will not meet the needs of a particular developer. Currently, when an integrated component lacks needed functionality, developers must either subclass the object and append the needed functionality, or else create an entirely new component.

The second challenge facing Internet application developers is that many useful legacy components often have not yet been converted to Web services. Often, legacy components run on platforms so foreign, that rather than try to convert the object to the new environment, the developer chooses to recreate the object entirely.

Both of the scenarios discussed above may consume a great deal of precious time and resources for development shops. The Dynamic Runtime Object Aggregation technology of the present invention was developed as a response to inadequacies, including those discussed above, in the current approach to application development.

### SUMMARY OF INVENTION

The invention comprises a method and apparatus for dynamic runtime object aggregation. An embodiment of the present invention provides a method for aggregation of inheritance, fields, functions, and types to objects dynamically at runtime, without breaking the original interface “contract”. In addition, a methodology for eclipsing all or part (down to the argument level) of pre-existing inheritance, fields, functions, and types is provided.

One or more embodiments of the present invention also provide for instantiating all the aggregated inheritance, data, functions, and types on an as needed and per item basis thus greatly reducing runtime overhead. Embodiments of the present invention provide a two-way transformation machinery that allows runtime objects to be accessed both within and without the middleware framework so that the interface becomes malleable to the problem at hand.

One or more embodiments implement design time cuing to visually present the aggregated portions of design time objects in the foreground. Visual cuing could be color coded and/or symbol coded.

### BRIEF DESCRIPTION OF THE DRAWINGS

FIG. 1 is a generalized illustration of the process of Dynamic Runtime Object Aggregation in accordance with an embodiment of the present invention.

FIG. 2 is a detailed illustration of the post aggregation functionality of an imported object in accordance with an embodiment of the present invention.

FIG. 3 is an illustration of a visual presentation of design time aggregation cuing in accordance with an embodiment of the present invention.

### DETAILED DESCRIPTION

The invention discloses a system and method for dynamically aggregating inheritance, data, functionality, and entire types to runtime objects. In the following description, numerous specific details are set forth to provide a more thorough description of embodiments of the invention. It will be apparent, however, to one skilled in the art that the invention may be practiced without these specific details. In other instances, well known features have not been described in detail so as not to obscure the invention.

The Dynamic Runtime Object Aggregation technology of the present invention allows developers to integrate and quickly re-shape a component to meet specific needs, regardless of the context of the development environment in which the component was created. With the present invention, it no longer matters that there is no single system in use by developers to create object types for consumption as Web services. In addition, integration of legacy components becomes a simple matter.

A developer using systems and methods of the invention may aggregate needed functionality to an imported object and change that object's interface without breaking the original functionality of the object. Any oversight that occurs during the original object design process may be compensated for at runtime. That is an enormous advantage of the present invention over the prior art. The structure a developer lends to an object (normally a very rigid thing at runtime), becomes with this invention highly plastic and adaptable. The interface becomes malleable to the problem at hand, without breaking the original interface. Such capability is important to future Internet application development.

The time-honored approach of subclassing an object to add inheritance, fields, or functions to that object at design time is the traditional way to adapt an object to new needs. Traditionally, these steps do not happen at runtime. The Dynamic Runtime Object Aggregation of the present invention may allow a developer to add inheritance, fields, and functions at runtime without a need to subclass the object, though this runtime approach is also addressed in this current invention.

In the present description, aggregation of an object may include adding new inheritance, data, and/or functionality to previously defined and implemented objects at runtime. Embodiments of the present invention may operate both on compiled and non-compiled objects.

Aggregation in embodiments of the present invention may depend on: the existence of an object with meta data that may be discovered or reverse engineered; a middleware framework in which the aggregation may occur; importation of the object into the middleware framework; creation of a middleware Meta Data Definition Object (MDDO); design time aggregation to the MDDO; creation of a runtime proxy based on the MDDO; runtime instantiation of aggregated portions of proxy as needed; and automated runtime transformation of object interfaces.

Discoverable Meta Data

In one or more embodiments of the present invention, it is presumed that meta data is discoverable at runtime. Meta data, or meta information is information about the structure of a class made available to other computing components external to the class. Meta data is high level information only and does not disclose the details of how the class operates at runtime.

Meta data may also be thought of as publicly exposed type definitions, such as the information exposed through the interfaces of a COM (Component Object Model) object at runtime. Most modern languages create objects with discoverable runtime type information, even for compiled components such as C++ compiled objects.

As long as a given object has interfaces that are publicly exposed (or that may be reverse engineered), embodiments of the present invention may be used to aggregate inheritance, data, and functionality to that object-without destroying any of the behavior or data intrinsic to the object in the system in which it was created. However, the aggregated data and functionality may drastically affect runtime behavior of an object within the context of the middleware framework in which aggregation takes place, and within any other system context in which the aggregated object may function.

With the availability of type information, the key to Dynamic Runtime Object Aggregation becomes the existence of a framework within which it is possible to add inheritance, data, and functionality schema to the existing type information of an object.

The Middleware Framework

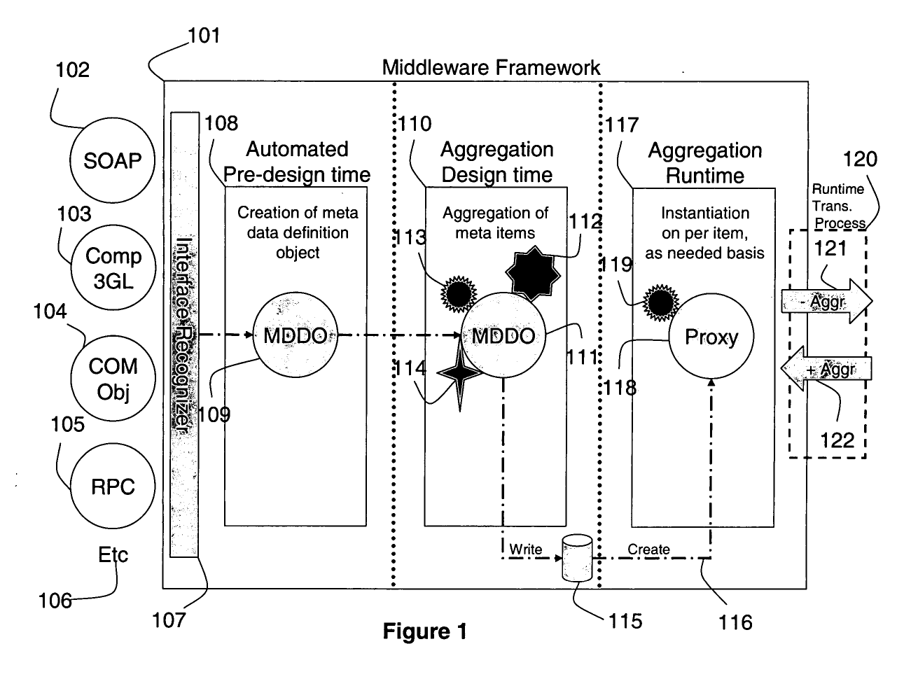

The middleware framework of the Dynamic Runtime Object Aggregation of the present invention is illustrated in FIG. 1. The middleware framework provides an environment in which a new design time (and then a second runtime) may be applied to already running objects and interfaces. In one embodiment, all of the aggregation methodologies occur within this middleware framework. In this illustration, the middleware framework is created with XML; however it should be apparent to those of skill in the art that this is a mere implementation detail and that other language systems could be used to achieve the same results.

For instance, the same affect could be achieved in the NET managed code server by creating an extension that supports Dynamic Runtime Object Aggregation. This could be achieved even without Microsoft's help because Microsoft has made NET easily extensible.

In an embodiment of the present invention, when a developer aggregates data and functionality to an object, both the meta data and the runtime operation of the object may be affected—but only in the context of the middleware framework and within any other system context in which the aggregated object may function.

Object Importation and Aggregation

In order to aggregate new behavior and functionality to an interface type or running object, the object must first be imported into the middleware framework. To do this, it is necessary to gain access to the meta types for runtime objects.

In one embodiment, the aggregation that occurs within the middleware framework may not affect the imported object per se, merely the inheritance, and/or data, and/or functionality of an object proxy. The reason the imported object remains unaffected by the aggregation is that the middleware system automatically creates a Meta Data Definition Object (MDDO) from the discoverable type definitions of the imported object.

The illustrated implementation of the middleware framework described above supports automated importation of SOAP (Simple Object Access Protocol) interfaces. The XML meta data for other runtime types (for example, C++) may be handcrafted or generated with other methods. The interface recognizer that allows automated importation of SOAP interfaces (using a WSDL parser) may be modified to automate importation of COM, CORBA, RPC, Java, or any other type with runtime interfaces that are either discoverable or reverse engineerable. Entire libraries (in the context of adding types to a library, for example) may also be imported in this manner.

Aggregation in the middleware framework becomes a second design time for imported objects. Aggregation accomplished at the middleware design time may be applied to the MDDO, not the original object. While design time is traditionally separated from runtime, in embodiments of the present invention, design time may also occur at runtime.

FIG. 1 illustrates the general process of Dynamic Runtime Object Aggregation in accordance with an embodiment of the present invention. This process occurs within the context of the Middleware Framework 101. The objects labeled 102 through 106 illustrate some of the many data types and interfaces (including entire libraries) that may be aggregated using this process. For instance, object 102 is a SOAP interface; object 103 is a 3GL compiled object; object 104 is a COM (Component Object Model) object; and object 105 is Remote Procedure Call (RPC) object. The label Etc. 106 illustrates the idea that the list of objects is theoretically infinitely expandable. The Interface Recognizer 107 is the portion of the middleware that differentiates between the various types of interfaces when a developer using this system imports a data type.

The dotted line 116 represents the development path of a type imported into the Middleware Framework 101. When a type is recognized by the Interface Recognizer 107, the middleware automatically generates an MDDO 109 (Meta Data Definition Object). The MDDO 109 may be a meta object instance of the class structure contained in the meta interfaces of the imported type. The MDDO 109 creation occurs during an Automated Pre-design time 108. Once the MDDO 109 creation is complete, the development path represented by dotted line 116 enters the Aggregation Design time 110. The MDDO 111 represents the MDDO 109 at Aggregation Design time 110.

At this time, a developer may aggregate new meta interface items (e.g. 112, 113, and 114) as needed. The aggregated MDDO 111 is then written to a database 115. At the Aggregation runtime 117, the meta data from the aggregated MDDO 111 stored on the database is used to create a Proxy object 118.

The aggregated meta items such as item 119 (which represents aggregated item 113 instantiated at runtime) may then be instantiated on a per item, as needed basis, greatly reducing overhead over conventional instantiation techniques. If the proxy object 118 is passed to another object or system, the object may pass through a Runtime Transformation Process 120.

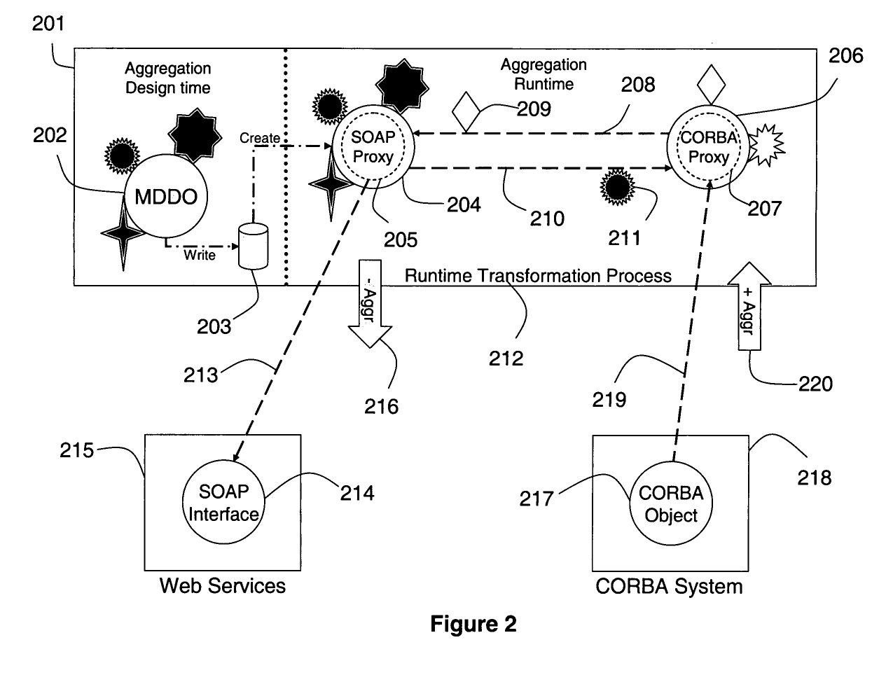

Runtime Transformation Process 120 is a two way process. For instance, outgoing transformations may remove aggregated elements from instantiated proxies (indicated by the “−Aggr” arrow 121), while incoming transformations may add aggregation (indicated by the “+Aggr” arrow 122). Aggregation transformation may occur on an as needed, per item basis. Transformation Process 120 is further discussed with the illustration of FIG. 2.

The Middleware “Aggregated Runtime”

In one or more embodiments, when aggregation is complete, the MDDO is written to a database. At runtime, the aggregated MDDO is instantiated as a Middleware Runtime Proxy Object that wraps a proxy for the imported type. Native calls made to the proxy for the imported object are passed to that object through the Middleware Runtime Proxy Object. Calls made to the aggregated portions of the Middleware Runtime Proxy Object may be handled solely by the Middleware Runtime Proxy Object, thus leaving the proxy created for the imported object unaffected by the aggregation. However, these aggregation calls may cause a call into the imported object as well. These details are more fully explained with the illustration of FIG. 2.

Instantiation on a Per Item, As Needed Basis

When the runtime proxy object is created within the system of the present invention, instantiation of the items aggregated to the MDDO occurs on a per item, as needed basis. This means that the Middleware Runtime Proxy Object first created may mirror exactly the original imported object. Aggregated inheritance, fields, functions, and types are instantiated only as they are accessed at runtime.

FIG. 2 is an expansion of principles illustrated in FIG. 1. FIG. 2 represents a more detailed view of the post aggregation functionality of an imported object. In this illustration, the MDDO 202 represents a Meta Data Definition Object complete with aggregated functionality. Once aggregation is complete, the MDDO 202 is written to the Database 203. At runtime when a SOAP or CORBA or other proxy object type is needed, the MDDO from the database 203 is used to create the Middleware Runtime Proxy Object 204 or 207. The Middleware Runtime Proxy Object 204 consists of a runtime instantiation of the aggregated MDDO 202. The Middleware Runtime Proxy Object 204 (instantiated from MDDO 202) wraps a SOAP Interface Proxy 205 (the non-aggregated portion of the MDDO 202). The non-aggregated portion of the MDDO 202 was created using meta data available in a SOAP interface imported to the Middleware Framework 201.

It should be apparent to those of skill in the art that the SOAP Interface Proxy 205 within the Middleware Runtime Proxy Object 204 serves only as an illustration of aggregation principles in the Middleware Framework 201. Any number of data types could have been used to demonstrate these principles. Likewise, the CORBA Proxy Object 207 contained within a second Middleware Runtime Proxy Object 206 serves as an example only. The Dynamic Runtime Object Aggregation of the present invention is in no way restricted to creations of proxy objects for these two interface types. Any discoverable interface type or any type that may be reverse engineered may be used to create proxy objects within the Middleware Framework 201 aggregation runtime environment.

In the example provided in FIG. 2, the same process may be used to create the CORBA Proxy object 207 which is wrapped by Middleware Runtime Proxy Object 206. The process is essentially the same for SOAP or CORBA or any other proxy type.

When a CORBA Object 217, which resides inside CORBA System 218, is needed in the Middleware Framework 201 (indicated by dotted line 219), the object reference undergoes a Runtime Transformation Process 212 that may instruct the Middleware Framework 201 to create a CORBA Proxy instance directly from the corresponding MDDO already created, aggregated, and stored in the database. The Middleware Framework also instantiates the portion of the MDDO wrapping the CORBA proxy and adds any appropriate aggregation (indicated by the “+Aggr” arrow 220) to Middleware Runtime Proxy Object 206.

Alternatively, a CORBA proxy object may be passed directly into the Middleware Framework 201, with the Runtime Transformation Process 212 initiating a database lookup for the MDDO corresponding to the previously imported CORBA class definition for CORBA Object 217. The Middleware Framework 201 then creates the appropriate CORBA Proxy object 207, and wraps that proxy object with the appropriate Middleware Runtime Proxy Object 206. Any items aggregated to the MDDO at Aggregation Design time may also be instantiated on a per item, as needed basis.

In like manner, when a SOAP or CORBA proxy object reference is passed out of the Middleware Framework 201, the wrapping Middleware Runtime Proxy Object and associated aggregations may be stripped from the interface reference by the Runtime Transformation Process 212, as indicated by the “−Aggr” arrow 216. In the example provided in FIG. 2, a reference (indicated by the dotted line 213) to the SOAP Proxy 205 is transformed by the Runtime Transformation Process 212 back into something (SOAP Interface instance 214) understood by the Web Services environment 215.

FIG. 2 also illustrates how the Middleware Framework 201 becomes a “virtual application framework”. The Middleware Framework 201 provides disparate runtime types the ability to communicate in a meaningful fashion. The dotted lines 208 and 210 indicate communication between the two Middleware Runtime Proxy Objects 204 and 206. This is possible because while SOAP Interface Proxy 205 may perform native SOAP calls and CORBA Proxy object 207 may perform native CORBA calls, each of these proxy objects are wrapped by a Middleware Runtime Proxy Object. Since the Middleware Runtime Proxy Objects are instantiations of MDDOs that recreate native interfaces in a middleware recognizable format, non-SOAP and non-CORBA communication may occur between SOAP Interface Proxy 205 and CORBA Proxy object 207 in the Middleware Framework 201 runtime through the mediation of Middleware Runtime Proxy Objects 204 and 206, essentially translating between disparate protocols.

The two geometrical shapes 209 and 211 (on lines 208 and 210 respectively) indicate that references to the aggregated portions of the two Middleware Runtime Proxy Objects 204 and 206 may also be passed from one aggregated proxy object to another at Middleware Framework 201 runtime. The Middleware Framework 201 runtime constitutes a virtual application framework through which natively disparate objects may interact in an integrated fashion to create an integrated application.

Field and Function Aggregation

Fields and functions which represent the original imported type may not natively possess the ability to interact with fields and functions aggregated in the middleware framework. This limitation may be overcome in the context of eclipsing, as discussed more fully below. The same kind of restriction does not however apply to aggregated functions in their abilities to access existing fields and functions of the imported object.

As an illustration, suppose a developer imports a 3GL compiled object called “Factory” and the Factory class contains fields OpNumber and IsFinished and functions doOperation and finishproduct. At aggregation design time, a developer may choose to add both new functions and new fields to the MDDO object created from the Factory class meta data.

The developer may add a newFunc1 that operates on existing fields, and a newFunc2 that operates on New Field1. The original functions in the Factory object (doOperation and finishProduct) may not operate on New Field1; however, the newly aggregated functions newFunc1 and newFunc2 may use New Field1 and add New Field1 to a parameter that is passed through to an original function. For example, newFunc1 might make use of New Field1 to compute a new OpNumber, which is a field that belongs to the original object.

This Factory class is just one example of the kind of interface types that may be aggregated to in the context of the middleware framework of the present invention. For instance, it is possible to aggregate data to a class that is a pure functional interface. Likewise, functionality may be aggregated to pure data interfaces. Not all interface types support both functions and data. Using this system however, it is possible to aggregate functionality and data to any type, regardless of native constraints.

### SOAP Example

A SOAP type provides a good example of an interface type that does not normally support both functions and data. The SOAP protocol is a restrictive type structure. Commonly, if a SOAP type has functions, the same type may not also have data fields. Likewise, if a SOAP type contains data, that same type may not have functions. The same may be true for other IDL-based types such as DCE (Distributed Computing Environment) and RPC (Remote Procedure Call). Using Dynamic Runtime Object Aggregation however, both fields and functions (including constructors, destructors, onLoad, etc.) may be present in the same type, just as they may with more traditional data types.

For example, suppose there is a SOAP type called “Person” containing fields called LastName, FirstName, Address, and PhoneNumber. Traditionally, the SOAP type Person may not have functions because it has fields. Using prior art methods, a developer who imports such a type into an Internet application and tries to add a function called setDateOfBirth, will find that the SOAP standard will not support this attempt. On the other hand, for a developer working within a middleware framework and using the principles of Dynamic Runtime Object Aggregation as explained in connection with FIG. 1 and FIG. 2 above, adding the function is not a problem.

Once the developer adds setDateOfBirth in the aggregation design time and the Middleware Runtime Proxy Object is instantiated, the function may operate on the various elements of the data type without breaking the overall meaning of the type Person. If the developer also wants to add a new field called CellNumber (perhaps the creator of the Person type overlooked this) this may also be done. In the traditional world of Internet application design, the only option for the developer wanting to add a new field to the SOAP interface, would be to subclass Person.

Type Aggregation

There are many ways in which Dynamic Runtime Object Aggregation may be implemented. For instance, in the case of the SOAP Person type example, meta data from one or more other types (for example, a type called Employee with both fields and functions) may be aggregated to the Person MDDO. When this aggregation is complete, the aggregated Person object (perhaps now an amalgam of two or more types) appears and functions as a single object. Since the original SOAP interface is not directly affected by the additions in the runtime environment, this new Person object may be used advantageously both within the Middleware framework, and in its original context outside the framework as a regular SOAP interface.

Aggregation within the middleware framework may take many forms. For instance, one may add data, functionality and inheritance created only in the middleware context, or one may choose to use meta data from compiled objects or from objects fabricated dynamically at runtime. It should be apparent to those of skill in the art that these are all merely implementation details.

Aggregation for Database Persistence

Aggregated fields are not limited to primitive types. An aggregated field might be two very complex types aggregated together. Returning to the example of the Person SOAP type, suppose the developer wants to add a database ID number to Person so the object may be persisted in a database. The developer could use one of the LastName, FirstName, or Address, fields as a foreign key and use the Person object unchanged. Doing so however, may constrain the developer to a less optimal way of persisting objects.

In other words, if a developer is creating an application that uses a specific kind of database ID number, that developer may want to persist data from any imported object in the same manner. If a developer has to create a new class for each imported object, this may be painful. Even sub classing an object may be problematic since subclassing requires a transformation back to the original object form in order to pass that object back to the originating system. Aggregating a field of type long to Person allows the developer to persist Person in a more optimal fashion.

Inheritance Aggregation

As discussed above, there is great need to update and successfully integrate legacy (i.e. 3GL) programs into other applications (particularly Internet applications) that are both consistent in behavior and powerful in functionality. The need for integration of disparate system types into a single application makes runtime inheritance modification extremely important.

The aggregation approach of the present invention greatly reduces transformation overhead in application workflow models. For instance, aggregation allows a developer to aggregate a data type without involving the original designer of the object concerned since the changes applied to an object using runtime aggregation are not actual changes applied to the type, but as in other cases of aggregation, are applied to the MDDO.

Every object system may have at least one root termination point in the inheritance of the objects in that system. At a termination point, a developer using Dynamic Runtime Object Aggregation may choose to inherit from yet another object system or object. By appending a new base type to the root of an inheritance system, it is possible to re-parent or change either a single object or an entire group of objects' inheritance without destroying the original inheritance.

Aggregating inheritance in this manner does not break the original behavior or data structure of an object. Instead, inheritance aggregation adds a great deal of power.

This does not mean that a developer could not corrupt an object, however the middleware framework in which aggregation takes place limits a developer's freedom to re-parent a type in a way that breaks an object's inheritance.

### Inheritance Aggregation Example

When a developer aggregates new fields and functions, the new functions may operate on both aggregated and previously existing fields. The aggregated functions may operate on types that have been aggregated to the base type as well.

For example, suppose a developer imports a type A with no super type defined. When a developer aggregates a meta data super class B onto the MDDO created for A, type A is not affected, because type A does not “know about” type B, and B does not “know about” A. This means there is no intersection of behavior. For example, if A has a func1 and a func2, neither of these functions may operate on class B. However, if a developer has created an aggregatedFunc1 on class A's MDDO, aggregatedFunc1 may act on aggregated type B.

Attempting this kind of inheritance aggregation directly in the context of a compiled class may raise all kinds of dependency issues for a compiler. That is why this kind of inheritance aggregation may more easily be accomplished in a runtime environment such as exists in the middleware system of the present invention.

For example, referring back to the SOAP Person example where the developer is using a particular form of database ID, the developer could add a new base type to the front of every object passed into the system. Rather than adding a database ID to each imported object, the developer may go to the root of each type and instead of a type lacking inheritance, or inheriting from root, the developer may cause the entire object system to inherit from the object type containing the needed database ID (DBID). In this way, all objects imported into the middleware framework from disparate systems may be persisted in a uniform manner in the data base.

Multiple Inheritance

Multiple inheritance aggregation is also possible using methodology of the present invention. For instance, inheritance may occur anywhere in the chain of inheritance, not merely at the root. The one caveat is that such inheritance ought to be accomplished with care so as not to break the inheritance of the actual object. As long as functions are defined as virtual, there should be no problem with multiple inheritance aggregation.

Eclipsing

Eclipsing is a specialized form of aggregation. Up to this point aggregation has been defined as attaching additional inheritance (types), fields, and functions, to the meta data of an imported type. Eclipsing here refers to modifying the non-aggregated meta interfaces of an imported type within the context of the MDDO. Like regular runtime aggregation, eclipsing also takes place at the middleware design time. Also, like regular runtime aggregation, eclipsing may act upon inheritance, types, fields, and functions.

Within the context of the middleware framework of the present invention, it is possible to modify existing meta interfaces as long as the intent of the original functionality and data is preserved and not broken. Eclipsing may be applied to a particular object in conjunction with regular aggregation, however it does not have to be. For instance, a field of an MDDO may be eclipsed without any further aggregation occurring.

There are two forms of eclipsing: Subclass eclipsing; and Override eclipsing. Subclass eclipsing substitutes one type for another. To insure the new type does not break the existing interface, the eclipsed type must inherit from the type being replaced.

For instance, suppose a developer imports an object Fred with a function foo (Fred.foo) and foo takes an object A as an argument—Fred.foo (ObjA). A developer could eclipse that function by changing the type of the argument of foo to ObjB as long as B inherits from A. Object B must inherit from object A so that the original object recognizes the calls of object B. Unless B inherits from A, the interface will not function properly at runtime.

Unlike overrides in traditional languages, override eclipsing is not a true virtual override, because override eclipsing does not involve inheritance subclassing. Rather, override eclipsing may be thought of as placing a filter in front of the original interface. Partial eclipsing of the interface occurs where data passed in or out through the interface is modified or the original interface is called, but the functionality is completely re-implemented. In addition, the filter may be used to completely obscure what is being overridden. In other words, the filter may act to create a total eclipse of the interface. Using override eclipsing a developer may block an interface from ever being called by the simple expedient of overriding the interface and throwing an exception each time the interface is called.

Override eclipsing occurs when a developer re-implements an imported interface type without changing (for example) a function's interface. In this way, a function from the original object may be used in a way not anticipated by the designer of that function.

Function Level Override Eclipsing

Function override eclipsing allows a developer to re-use a function in a way that is completely different from the original implementation. To do this, the developer would simply repeat the signature of the function and then add new functionality in the body of the function.

For example, a developer may want to override a function called finishProduct ( ). The meta data for an imported function does not reveal the implementation of the body of the function. To override a function finishproduct, the developer might re-implement the function by calling it AugFinishProduct ( ) and then at design time add a new body for the function to the existing meta data.

Developers may find function level eclipsing useful in many contexts, one of which would be to track how many times a particular function is called. To do this, the developer may override the function and add logic that increments a count in a log file each time the overridden function is called.

Field Level Override Eclipsing

In the same way, override eclipsing may be used to log access to a field. In addition, subclass eclipsing may be used to change the type of a field. For example, in the case of the Person SOAP type example, Person has a field called Address. An aggregated field called SuperAddress may be substituted for Address. Although SuperAddress eclipses the original Address field, the object outside the middleware framework will properly handle the data passed to it from SuperAddress as long as SuperAddress inherits from the Address base type.

Inheritance Override Eclipsing

The same principles apply to inheritance override eclipsing. For example, if there is an object called shopFloor in a project, a developer could substitute an object called myShopFloor as long as this object inherits from shopFloor and does not break the intent of the shopFloor object. Objects may be eclipsed and overridden in the same way discussed for functions and fields.

Runtime Proxy

Dynamic Runtime Object Aggregation of meta data to an imported data type is in reality merely creation of additional interface definitions within the context of the middleware framework. At middleware application design time, the imported type is not directly aggregated. All that is truly modified is the Meta Data Definition Object (MDDO) automatically generated within the middleware framework from the discoverable or reverse engineered meta data of the imported data type.

The MDDO is in essence an object that will become the middleware runtime wrapper for the imported data type. At runtime, the MDDO is read from the data base and used to create the Middleware Runtime Proxy Object. This process happens automatically at runtime. Without the MDDO, instantiation of the original object within the context of the middleware framework may not be possible.

When the MDDO is instantiated at runtime as the Middleware Runtime Proxy Object, the additional data and functionality aggregated at design time may also be instantiated on an as needed and per item basis. This means that if a particular function is never called in a particular application instance, that aggregated function need not be instantiated on the Middleware Runtime Proxy Object.

In other words, when the object proxy within the middleware runtime system is instantiated, only the core original object functionality need be instantiated. Thus, no aggregated fields or functions need to be instantiated until the specific field or function is actually accessed. Therefore, fields or functions not accessed during the life of the object may never be instantiated. This results in tremendous savings of overhead and memory allocation.

For instance, suppose there is a Middleware Runtime Proxy Object (MRPO) with a field.x. If another object requests a pointer to x, the runtime interface checks to see if field x has been instantiated yet. If x has yet to be instantiated the interface creates x and then returns it. That means that the runtime operator may make a call for MRPO.x.y.z thus, in effect, instantiating three fields for the first time dynamically at runtime.

The same principle applies to calling a function. In this case the call might be MRPO.func (x.y), where x.y is the argument. And since the argument itself contains two fields (x.y), if these fields are not yet instantiated, they are created and instantiated at this time. To understand the power of this optimization, consider the more traditional procedure, which is to create all fields and functions regardless of whether they are ever actually used in the life span of a particular application instance.

Automation of Object Transformation

Once aggregation (whether regular runtime aggregation or eclipsing aggregation) is complete, the aggregated object should be able to function both in the middleware framework and outside this context. Calls native to the wrapped proxy type pass through the Middleware Runtime Proxy Object interface back to the object running outside the middleware system. Aggregations local to the middleware may not return to the server controlling access to the non-aggregated object. Thus the original object may remain completely unaffected by the aggregations created within the middleware framework. This transformation happens dynamically at runtime.

This runtime transformation exists as a mechanism in the middleware framework to take runtime objects that have been aggregated and transform them automatically to and from their original source in the type structure that they originally represent. In other words, not only may objects be aggregated to, their originating systems may interact with the Middleware Runtime Proxy Object just as though that object is the non-aggregated original type.

Object Transformation Analogy

A good analogy for the automated nature of Dynamic Runtime Object Aggregation may be seen in Hasbro, Inc.'s Play-Doh® Fun Factory®. Imported objects may be seen as a blob of Play-Doh.

When an object “blob” is aggregated to in the middleware framework, the blob object acquires different interface characteristics, just as a blob of Play-Doh acquires a new shape when it is pushed into the Fun Factory. The Play-Doh acquires the shape of the mold through which it is extruded, for example a star. The shape of the extruded Play-Doh is easily changed by sliding the mold bar over to a new shape. Just as a person catching the star-shaped Play-Doh extrusion usually wads the Play-Doh back up into a shapeless blob, the object assumes its original shape when it is passed back out of the middleware runtime framework and returns to its originating system.

The idea of this analogy is that an object may be shaped or morphed into a new shape without losing any of its original behavior or functionality, just as the basic nature of Play-Doh is unchanged by the process of extrusion it undergoes in the Fun Factory. The same blob of Play-Doh may be reused repeatedly without any problem. There are certain limits to what may be done to both the object and the Play-Doh of course. For example, if two separate blobs are mixed as they are pressed into the Fun Factory, what comes out the other side will be a mix of the two colors, nor may they ever again be cleanly separated. Likewise, if certain rules of aggregation are ignored, aggregated objects may not be able to return to their original forms. This means that it is important to preserve the original structure of an object when aggregating data, functionality, or inheritance.

For example, if someone were to borrow a friend's car to deliver pizza in, it would be wise for that person to use magnetic panel logos to advertise the fact that the car is being used as a pizza delivery car, as opposed to painting the logo on the car, or worse yet, to engrave the logo into the metal of the door. The goal in any Dynamic Runtime Object Aggregation is to leave the original behavior of the object unchanged in its originating context.

As long as the object is used only in the middleware system, runtime transformation is not required. Runtime transformation only makes a difference if the object is being accessed from outside of the middleware framework by the system from which it originally came. In addition, it is possible to pass references to the aggregated proxy object outside the middleware framework to other systems not dependant on the original shape of the object. In essence, in this situation, the developer is merely creating a new object type that may in turn be used as a single entity by other developers making use of Web services to build integrated applications.

Another embodiment of the present invention is aggregation design time cuing. What is meant by this term is the ability to rapidly determine which parts of an imported object are original meta data, and which are aggregations added at design time. One method employed to cue the developer as to which parts of an object are original and which are aggregated is color coding. In one embodiment, the original portions of an imported object's meta data are colored blue while the aggregated sections are yellow, for example. The use of colors as a visual cue is simply an implementation detail however.

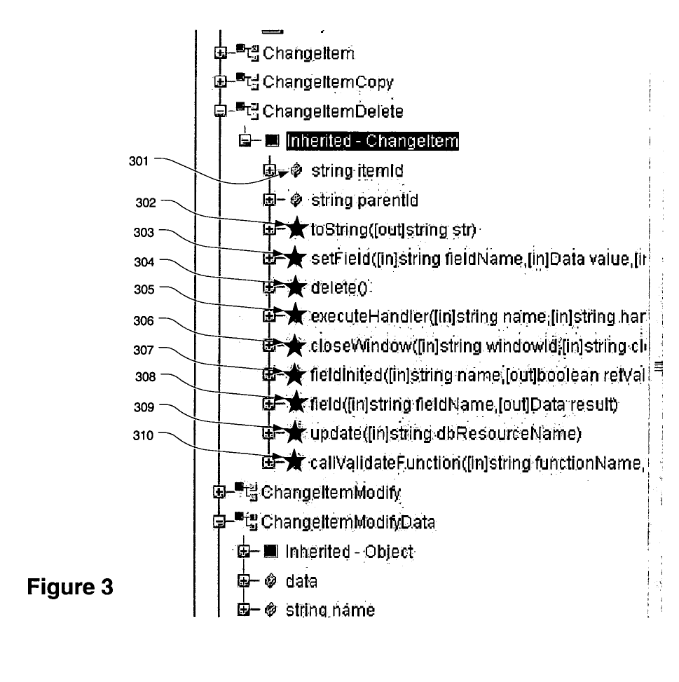

There are many ways to create a visual representation of aggregated versus imported meta data. For instance, specific symbols may be appended automatically to each aggregated item. For example, as illustrated in FIG. 3, a star symbol is used to denote aggregated sections of imported code (e.g. symbols 302, 303, 304, 305, 306, 307, 308, 309, and 310). Symbol 301 is a regular symbol denoting the original portions of an imported object's meta data.

In another example, the prefix “Aug” could be appended to aggregated pieces of code. It should be apparent to one of skill in the art that the visual nature of aggregation cuing is merely an implementation detail. It should be possible for example, to cause a chime to sound each time a mouse passes over aggregated code.

Thus, a method and apparatus for dynamic runtime object aggregation have been described. Particular embodiments described herein are illustrative only and should not limit the present invention thereby. The invention is defined by the claims and their full scope of equivalents.

1. A method for runtime object aggregation comprising:
obtaining a meta data definition object corresponding to an object definition for an item originating from a system external to a runtime environment;
aggregating one or more meta interface elements to said meta data definition object;
instantiating a runtime proxy object from a non-aggregated portion of said meta data definition object; and
appending one or more interface elements to said runtime proxy object, wherein said one or more interface elements are instantiated from an aggregated portion of said meta data definition object.

2. The method of claim 1, further comprising:
storing said meta data definition object in a data store.

3. The method of claim 1, wherein obtaining said meta data definition object comprises:
importing a first object implementing said object definition; and
reading an exposed meta data definition from said first object.

4. The method of claim 1, wherein said one or more interface elements are each instantiated as needed during runtime.

5. The method of claim 1, wherein aggregating said one or more meta interface elements comprises:
appending super class meta data to said meta data definition object.

6. The method of claim 5, wherein said super class meta data is appended to an inheritance chain of said meta data definition object.

7. The method of claim 5, wherein appending said one or more interface elements to said runtime proxy object comprises:
associating one or more inherited functions of a super class with said runtime proxy object, wherein said super class corresponds to said super class meta data.

8. The method of claim 5, wherein appending said one or more interface elements to said runtime proxy object comprises:
associating one or more inherited data fields of a super class with said runtime proxy object, wherein said super class corresponds to said super class meta data.

9. The method of claim 1, wherein aggregating said one or more meta interface elements comprises:
adding function meta data to said meta data definition object, wherein said function meta data defines one or more functions.

10. The method of claim 1, wherein aggregating said one or more meta interface elements comprises:
adding field meta data to said meta data definition object, wherein said field meta data defines one or more data fields.

11. The method of claim 1, wherein aggregating said one or more meta interface elements comprises:
adding meta data of a second object type to said meta data definition object.

12. The method of claim 1, wherein aggregating said one or more meta interface elements comprises:
performing subclass eclipsing by replacing meta data reciting a first data type with meta data reciting a second data type.

13. The method of claim 12, wherein said second data type inherits from said first data type.

14. The method of claim 1, wherein aggregating said one or more meta interface elements comprises:
performing override eclipsing by providing meta data to re-implement a pre-existing interface element of said object definition.

15. The method of claim 1, wherein aggregating said one or more meta interface elements comprises:
using data defined by a developer, wherein said data identifies said one or more meta interface elements.

16. The method of claim 15, wherein aggregating said one or more meta interface elements further comprises:
providing to said developer one or more visual cues that differentiate aggregated elements of said meta data definition object from non-aggregated elements of said meta data definition object.

17. The method of claim 1, wherein said runtime proxy object is instantiated in response to a transfer of an object reference into said runtime environment.

18. The method of claim 17, further comprising:
detecting the transfer of said object reference out of said runtime environment; and
passing a non-aggregated portion of said runtime proxy object outside of said runtime environment.

19. The method of claim 17, further comprising:
said runtime proxy object passing a native interface call to an interface object for processing, wherein said interface object corresponds to said object reference.

20. The method of claim 1, wherein appending said one or more interface elements to said runtime proxy object comprises:
detecting a first-time reference to an interface element corresponding to one of said one or more meta interface elements;
instantiating said interface element from said aggregated portion of said meta data definition object; and
aggregating said interface element to said runtime proxy object.

21. A computer program product comprising a computer readable medium having program code embodied therein for providing runtime object aggregation in a runtime environment, said computer program product comprising:
program code configured to cause a computer to obtain a meta data definition object corresponding to an object definition for an item originating from a system external to said runtime environment;
program code configured to cause a computer to aggregate one or more meta interface elements to said meta data definition object;
program code configured to cause a computer to instantiate a runtime proxy object from a non-aggregated portion of said meta data definition object; and
program code configured to cause a computer to append one or more interface elements to said runtime proxy object, wherein said one or more interface elements are instantiated from an aggregated portion of said meta data definition object.

22. The computer program product of claim 21, further comprising:
program code configured to cause a computer to store said meta data definition object in a data store.

23. The computer program product of claim 21, wherein said program code configured to cause a computer to obtain said meta data definition object comprises:
program code configured to cause a computer to import a first object implementing said object definition; and
program code configured to cause a computer to read an exposed meta data definition from said first object.

24. The computer program product of claim 21, wherein said program code configured to cause a computer to append said one or more interface elements to said runtime proxy object comprises:
program code configured to cause a computer to instantiate each interface element as needed during runtime.

25. The computer program product of claim 21, wherein said program code configured to cause a computer to aggregate said one or more meta interface elements comprises:
program code configured to cause a computer to append super class meta data to said meta data definition object.

26. The computer program product of claim 25, wherein said super class meta data is appended to an inheritance chain of said meta data definition object.

27. The computer program product of claim 25, wherein said program code configured to cause a computer to append said one or more interface elements to said runtime proxy object comprises:
program code configured to cause a computer to associate one or more inherited functions of a super class with said runtime proxy object, wherein said super class corresponds to said super class meta data.

28. The computer program product of claim 25, wherein said program code configured to cause a computer to append said one or more interface elements to said runtime proxy object comprises:
program code configured to cause a computer to associate one or more inherited data fields of a super class with said runtime proxy object, wherein said super class corresponds to said super class meta data.

29. The computer program product of claim 21, wherein said program code configured to cause a computer to aggregate said one or more meta interface elements comprises:
program code configured to cause a computer to add function meta data to said meta data definition object, wherein said function meta data defines one or more functions.

30. The computer program product of claim 21, wherein said program code configured to cause a computer to aggregate said one or more meta interface elements comprises:
program code configured to cause a computer to add field meta data to said meta data definition object, wherein said field meta data defines one or more data fields.

31. The computer program product of claim 21, wherein said program code configured to cause a computer to aggregate said one or more meta interface elements comprises:
program code configured to cause a computer to add meta data of a second object type to said meta data definition object.

32. The computer program product of claim 21, wherein said program code configured to cause a computer to aggregate said one or more meta interface elements comprises:
program code configured to cause a computer to perform subclass eclipsing by replacing meta data reciting a first data type with meta data reciting a second data type.

33. The computer program product of claim 32, wherein said second data type inherits from said first data type.

34. The computer program product of claim 21, wherein said program code configured to cause a computer to aggregate said one or more meta interface elements comprises:
program code configured to cause a computer to perform override eclipsing by providing meta data to re-implement a pre-existing interface element of said object definition.

35. The computer program product of claim 21, wherein said program code configured to cause a computer to aggregate said one or more meta interface elements comprises:
program code configured to cause a computer to use data defined by a developer, wherein said data identifies said one or more meta interface elements.

36. The computer program product of claim 21, wherein said program code configured to cause a computer to aggregate said one or more meta interface elements comprises:
program code configured to cause a computer to provide to said developer one or more visual cues that differentiate aggregated elements of said meta data definition object from non-aggregated elements of said meta data definition object.

37. The computer program product of claim 21, wherein said program code configured to cause a computer to instantiate said runtime proxy object is responsive to a transfer of an object reference into said runtime environment.

38. The computer program product of claim 37, further comprising:
program code configured to cause a computer to detect a transfer of said object reference out of said runtime environment; and
program code configured to cause a computer to pass a non-aggregated portion of said runtime proxy object outside of said runtime environment.

39. The computer program product of claim 37, further comprising:
program code configured to cause a computer to pass a native interface call to an interface object for processing, wherein said interface object corresponds to said object reference.

40. The computer program product of claim 21, wherein said program code configured to cause a computer to append said one or more interface elements to said runtime proxy object comprises:
program code configured to cause a computer to detect a first-time reference to an interface element corresponding to one of said one or more meta interface elements;
program code configured to cause a computer to instantiate said interface element from said aggregated portion of said meta data definition object; and
program code configured to cause a computer to aggregate said interface element to said runtime proxy object.

41. A method for performing object aggregation comprising:
importing one or more object interfaces into an aggregation environment;
identifying a respective interface definition for each of said object interfaces;
encapsulating each respective interface definition in a respective meta data definition object;
aggregating one or more meta interface elements to each respective meta data definition object in response to design input;
storing each respective meta data definition object in a persistent storage medium; and
at runtime, transforming one or more of said object interfaces into one or more respective runtime proxy objects instantiated from respective meta data definition objects within said persistent storage medium.

42. The method of claim 41, wherein aggregating said one or more meta interface elements to each respective meta data definition object comprises:
adding one or more interface elements to two or more meta data definition objects to configure runtime cooperation in said aggregation environment between two or more runtime proxy objects corresponding to two or more object interfaces that originate from two or more disparate systems.

43. The method of claim 41, further comprising:
providing visual cuing to a developer at design time to differentiate between aggregated portions of said meta data definition objects and non-aggregated portions of said meta data definition objects.

44. An aggregation environment comprising:
an interface recognizer configured to receive an imported object interface and create a corresponding meta data definition object;
a developer interface configured to receive input that identifies one or more meta interface elements to aggregate to a specified meta data definition object;
a persistent storage comprising one or more meta data definition objects; and
a runtime transformation process configured to instantiate a runtime proxy object from a first meta data definition object in response to a transfer into said aggregation environment of a reference to a first object, wherein said first meta data definition object corresponds to an object definition implemented by said first object.

45. The aggregation environment of claim 44:
wherein said runtime proxy object is instantiated from a non-aggregated portion of said first meta data definition object; and
wherein said runtime transformation process is further configured to instantiate an interface element from an aggregated portion of said first meta data definition object upon a first referencing of said interface element, and aggregate said interface element to said runtime proxy object.

46. The aggregation environment of claim 44:
wherein said runtime transformation process is further configured to pass a non-aggregated portion of said runtime proxy object out of said aggregation environment when a reference to said runtime proxy object is transferred outside of said aggregation environment.

47. The aggregation environment of claim 44:
wherein said runtime proxy object is configured to pass a native interface call to said first object for processing by a native interface of said first object.

48. The aggregation environment of claim 44:
wherein said runtime proxy object is accessible to calls originating from within said aggregation environment and from outside of said aggregation environment.

49. The aggregation environment of claim 44:
wherein said developer interface is configured to provide visual cuing with respect to a selected meta data definition object, wherein said visual cuing differentiates aggregated elements from native elements of an original object definition.

50. The aggregation environment of claim 44, wherein each of said one or more meta interface elements corresponds to at least one interface element from the set of interface elements comprising:
a super class defining one or more inherited elements;
a type;
a field; and
a function.

51. The aggregation environment of claim 44:
wherein said developer interface is configured to detect an aggregation configuration in which an aggregated interface element is configured to eclipse a native interface element by substituting a native type with a substitute type, where said substitute type does not inherit from said native type.

52. The aggregation environment of claim 44:
wherein said developer interface is configured to detect an aggregation configuration in which an aggregated interface element is configured to override a native interface element without supporting associated native calls.
